(19) United States
(12) Patent Application Publication
(10) Pub. No.: US 2024/0397844 A1
(43) Pub. Date: Dec. 5, 2024

(54) STABLE OPERATION OF A DISC TILLAGE TOOL AT HIGH OPERATIONAL SPEEDS

(71) Applicant: KUHN KRAUSE, INC., Hutchinson, KS (US)

(72) Inventors: Eric DAWSON, South Hutchinson, KS (US); Jesse NININGER, Hutchinson, KS (US); Reid RAINS, Inman, KS (US); Kevin READE, Hutchinson, KS (US)

(73) Assignee: KUHN KRAUSE, INC., Hutchinson, KS (US)

(21) Appl. No.: 18/326,595

(22) Filed: May 31, 2023

(51) Int. Cl. A01B 33/02; A01B 33/08; A01B 51/04; A01B 63/111; A01B 63/22

(52) U.S. Cl. CPC A01B 33/024; A01B 33/025; A01B 33/082; A01B 33/087; A01B 51/04; A01B 63/1115; A01B 63/22

(57) ABSTRACT

A tillage tool achieves stability at higher speed ranges by providing stabilization with additional damping through damping elements on the front support wheels and on the constant level linkage and on the rear tool. The tillage tool maintains maximally one longitudinally positioned unsuspended load path to the ground provided by unsuspended depth gauging wheels longitudinally positioned parallel to a front to rear rocking axis to allow for constant settings throughout the depth, speed, and field condition ranges.

### BACKGROUND

### Technical Field

The present invention relates to the field of disc tillage tools. More specifically, the present invention relates to a stability control system for stable operation of the disc tillage tool, at high speeds greater than 8 mph field speed.

### Description of the Related Art

Disking breaks up clods and surface crusts, thereby improving soil granulation, surface uniformity and reducing soil erosion. It can be performed at a depth of 4-6 in.

High speed disc tools include discs that are mounted in lateral ranks rather than the traditional angled gangs. Typically, each disc is individually mounted to the frame with its own bearing and overload protection. In some embodiments, stability systems can also apply to conventional tandem discs.

Disc tillage tools can become unstable at high speed ranges and in certain soil conditions. Instability causes uneven field finish which is detrimental to planting and harvest machinery. Uneven soil surfaces can be caused by a machine which bounces or hops as it works the field. Uneven soil surfaces can be the result of too rigid a chassis design and/or the rear blades trying to climb over the wave of soil being thrown at them from the front gangs and/or a roller trying to climb the wave of soil thrown at it by the rear gangs. Common instability can be seen during operation as an oscillating rocking of the machine diagonally corner to corner or pitching front to rear. This uneven field finish resembles a washboard like pattern in the worked soil.

Some conventional solutions to this rocking are to increase or decrease operational speed or change the depth of operation. Such conventional solutions are not desirable. Decreasing operational speeds reduces the amount of ground worked in a given time. The ability to increase operational speed is limited by the power of the towing tractor. The operator should be able to choose the depth of operation without concern for machine stability.

Some conventional solutions provide for overhead protection for many tillage components by using springs. However, such conventional solutions lack provisions for instability of the machine itself.

In view of the above, there is a need for stable operation of disc tillage tools, especially at higher speed ranges.

### SUMMARY OF THE INVENTION

An aspect is a towable disc tillage tool, that can include a plurality of discs for mixing soil at a predetermined depth; and a stability control system including a combination of mechanical and hydraulic dynamic force control through damping of a leveling linkage, front support wheels, rear tools and position of the depth gauging wheels.

### BRIEF DESCRIPTION OF THE DRAWINGS

These and other advantages of the invention will become more apparent and more readily appreciated from the following detailed description of the exemplary embodiments of the invention taken in conjunction with the accompanying drawings where:

FIGS. 1A, 1B are a side view of a tillage tool;

FIG. 2 is global view of a tillage tool, in accordance with an exemplary aspect of the disclosure;

FIG. 3 is a side view of a front hydraulic actuator, in accordance with an exemplary aspect of the disclosure;

FIGS. 4A, 4B are detailed views of the front hydraulic actuator, in accordance with an exemplary aspect of the disclosure;

FIG. 5 is a schematic for a hydraulic system, in accordance with an exemplary aspect of the disclosure;

FIG. 6 is a side view of a tillage tool showing relative displacement for the location of a damping element, in accordance with an exemplary aspect of the disclosure;

FIG. 7 is a leveling spring damper system, in accordance with an exemplary aspect of the disclosure;

FIG. 8 is a schematic of a tillage tool with a depth gauging wheel located near the center of gravity, in accordance with an exemplary aspect of the disclosure;

FIG. 9 is a schematic of a rear tool system, in accordance with an exemplary aspect of the disclosure;

FIGS. 10A, 10B are detailed views of the rear tool hydraulic actuator, in accordance with an exemplary aspect of the disclosure;

FIG. 11 is a schematic of a hydraulic cylinder to adjust the wing depth gauging wheels, in accordance with an exemplary aspect of the disclosure; and

FIG. 12 is a detailed view of the adjustable length hydraulic cylinder, in accordance with an exemplary aspect of the disclosure;

### DETAILED DESCRIPTION OF THE PREFERRED EMBODIMENTS

Various methods, devices, and apparatuses are described below to provide an example of at least one embodiment of the claimed subject matter. No embodiment described below limits any claimed subject matter and any claimed subject matter may cover apparatuses and methods that differ from those described below. The claimed subject matter is not limited to methods, devices, and apparatuses having all of the features of any one methods, devices, or apparatuses described below or to features common to multiple or all of the methods, devices, and apparatuses described below. Subject matter that may be claimed may reside in any combination or sub-combination of the elements or process steps disclosed in any part of this document including its claims and figures. Accordingly, it will be appreciated by a person skilled in the art that methods, devices, and apparatuses disclosed in accordance with the teachings herein may embody any one or more of the features contained herein and that the features may be used in any particular combination or sub-combination that is physically feasible and realizable for its intended purpose.

Furthermore, it is possible that methods, devices, and apparatuses described below is not an embodiment of any claimed subject matter. Any subject matter that is disclosed in and methods, devices, and apparatuses described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

It will also be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein. For example, the application of a tillage machine stability system, force control hydraulic systems and single screw length adjustment as describe herein, in part or as a combination, is not limited to high speed discs but can apply to conventional discs, vertical tillage, cultivators, subsoilers, or any other tillage machine where stability control, force control or length adjustment is needed.

A disturbance such as a rut in a field can cause the tillage machine to start to oscillate in a rocking motion. Because of the digging nature of discs, without sufficient damping, once oscillation has started it will self-perpetuate as the front rank of discs dig a depression that will cause a new disturbance in the following components such as tires or the rear rank of discs. A disclosed solution provides stability by increasing the damping ratio of the machine as a system, causing the system to be critically damped or even overdamped. A critically damped or overdamped system will oscillate less with each subsequent cycle allowing the machine to quickly resume stable operation.

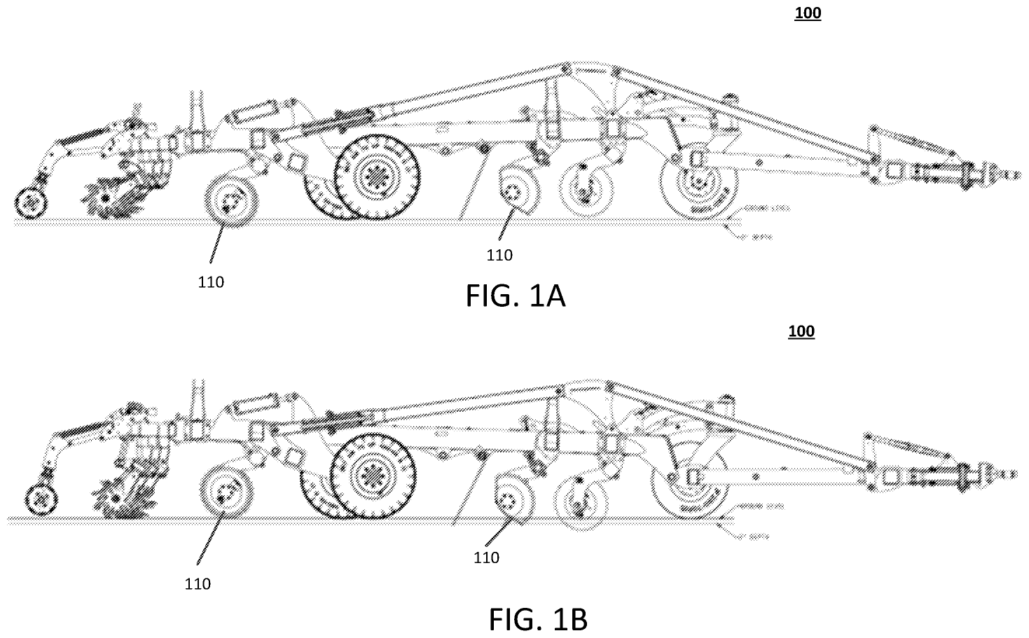

FIGS. 1A and 1B illustrate the rocking positions of the disc tillage tool that occur due to instability. Referring to FIG. 1A, illustrated therein is a side view of a towable disc tillage tool 100. High speed disc tools include discs that are mounted in lateral ranks rather than the traditional angled gangs. The disc tillage tool 100 can include discs arranged in a lateral rank 110. Each lateral rank 110 can include three or more discs (also referred to as baldes). In some embodiments, the disc tillage tool 100 may include more than one lateral rank of discs 110. Typically, each disc is individually mounted to the frame with its own bearing and overload protection. As can be seen in FIGS. 1A and 1B, the lateral ranks of discs 110 operate in an oscillating rocking motion pitching front to rear. The rocking motion can also occur corner to corner.

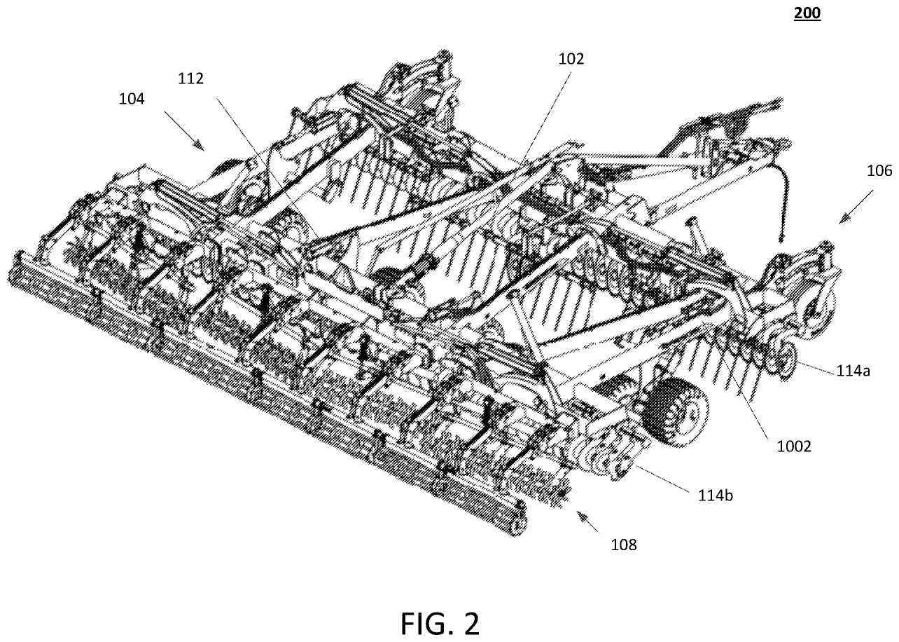

FIG. 2 is global view of a towable disc tillage tool. The disc tillage tool 200 can be configured with a leveling link 102, depth gauging wheels 104, a front support wheel 106, a center depth gauging wheel hydraulic actuator 112, a first lateral rank of discs 114a, a second lateral rank of discs 114b, a wing depth gauging wheel hydraulic actuator 1002, and one or more rear tools 108 for working soil.

Stable operation of the tillage tool 200 is enabled by increasing the damping ratio by way of shock absorbers added to the leveling linkage system 102 and hydraulic flow restriction added to the front support wheel system 106 and to the rear tool 108 through a pressure relief valve.

A constant flow pressure relief aspect of the front support wheel system 106 and rear tool 108 allows consistent operation regardless of depth by maintaining a constant pressure in a hydraulic actuator regardless of the position of the actuator. The pressure in the actuator can be adjusted if needed to provide more or less support to the tillage disc tillage tool by the front support wheels 106.

The location of the depth gauging wheels 104 is important to the stiffness of the spring in the leveling link 102. If the depth gauging wheels 104 are too far in front or behind the load balance point of the tillage tool 100 the spring must be very stiff to keep the tillage tool level as depth, speed and field conditions change. If the leveling spring is too stiff, it will not have sufficient travel for energy dissipation by the shock absorbers. When the depth gauging wheels 104 are at or near the load balance point of the tillage tool, they act as a fulcrum for the tool and a spring can be used that provides sufficient travel for shock absorbers.

### Front Support Wheels Active Response and Damping

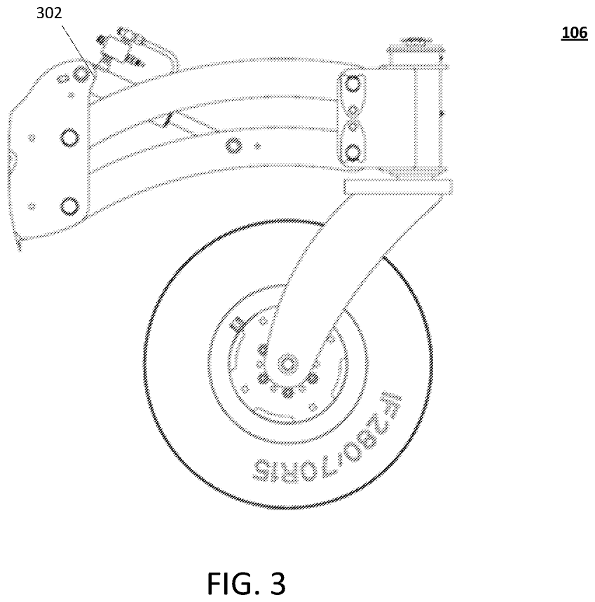

FIG. 3 illustrates a front support wheel with a front hydraulic actuator 302. A front support wheel system 106 can include one or more front support wheels. Position controlled front support wheels 106 store and release energy as the ground level changes. This energy cannot be dissipated within the tillage tool 200.

A conventional approach is to use a position controlled front support wheel with either a rigid connection to the frame or with a spring relief for overload protection. A position-controlled system cannot dampen vertical motion but only stores and releases energy aggravating tool instability. A load-controlled system, however, dissipates energy which dampens tool vertical motion.

In one embodiment, the tillage tool 200 is dampened through a pressure relief in a constant flow pressure relief hydraulic system in the front support wheel system 106.

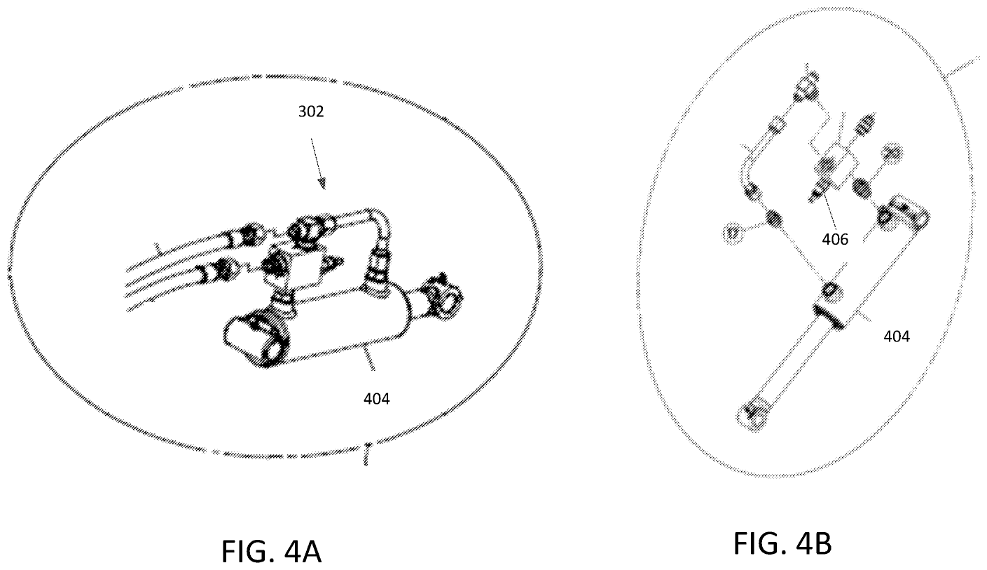

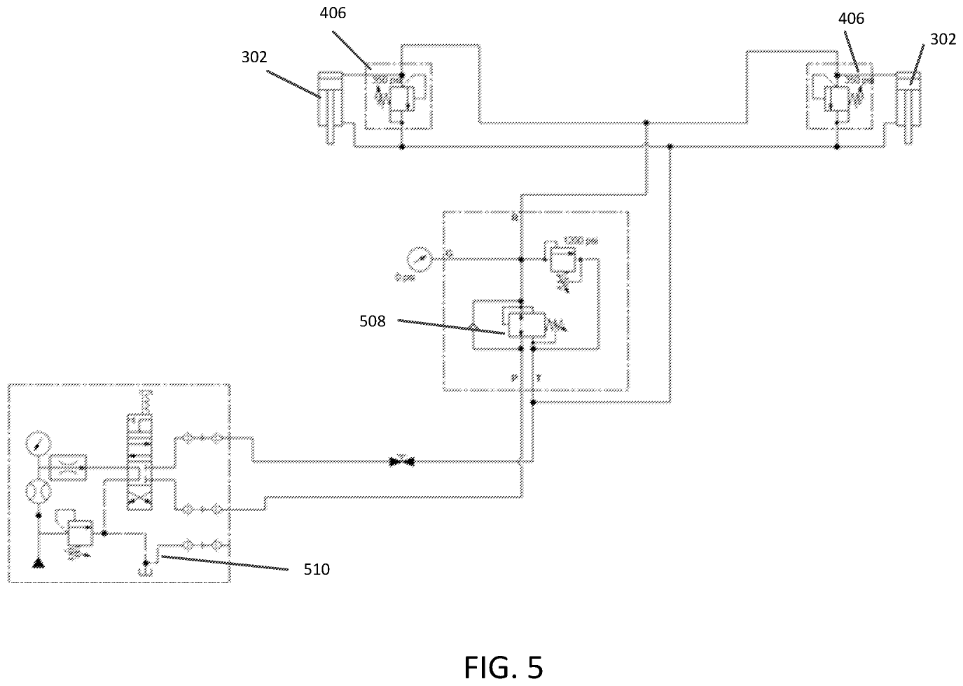

FIGS. 4A and 4B are a detailed view of a front hydraulic actuator 302 in the constant flow pressure relief system. FIG. 5 is a schematic of a hydraulic system for the front hydraulic actuator 302. A hydraulic cylinder 404 is used to allow the front support wheels to follow the contour of the ground. A pressure reducing valve 508 is used to provide a constant pressure to the hydraulic cylinder as the cylinder volume increases due to a lowering of the front support wheel. A pressure relief valve 406 is located as close as possible to the hydraulic cylinder 404 and is used to discharge excess oil to the other end of the hydraulic cylinder 404 and back to a hydraulic tank 510 when there is a rapid raising of the front support wheel.

This hydraulic reducing and relief system maintains a set force on the front support wheel regardless of the change in the wheel's position relative to the frame, while at the same time dissipating energy as oil flows through the relief valve 406.

### Front to Rear Rocking Dynamic Control Through a Leveling Spring Damper System

A disc like tool with a leveling system, while working, is primarily vertically supported by a tractor at a drawbar and at the depth gauging wheels. The disc tool itself may also provide significant support if the ground is sufficiently hard. However, in soft ground, the discs will provide very little support. As the mass of the tillage tool is vertically accelerated, due to some disturbance from the ground, energy is stored in the frame through the leveling system. The stiffer the leveling system, the more energy it can store. Adding springs and shock absorbers to the leveling system both reduce the amount of energy the system can store and dissipate that energy.

Conventional approaches for leveling systems provide springs for overload protection as high energy can cause mechanical failures. However, without damping elements energy is only stored and released by the spring and not dissipated. When the ground is hard the ground can provide sufficient energy dissipation if the forward speed of travel is not too high. However, in soft ground or at high travel speeds the damping from the ground can be insufficient to dissipate enough energy for the tillage tool to remain stable.

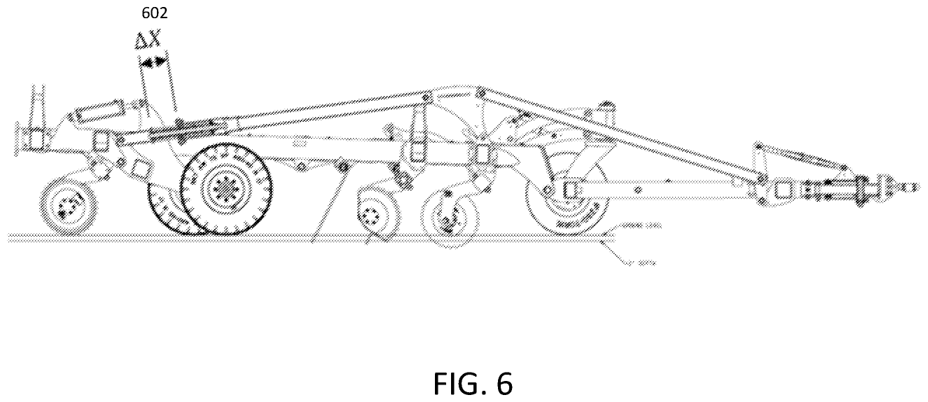

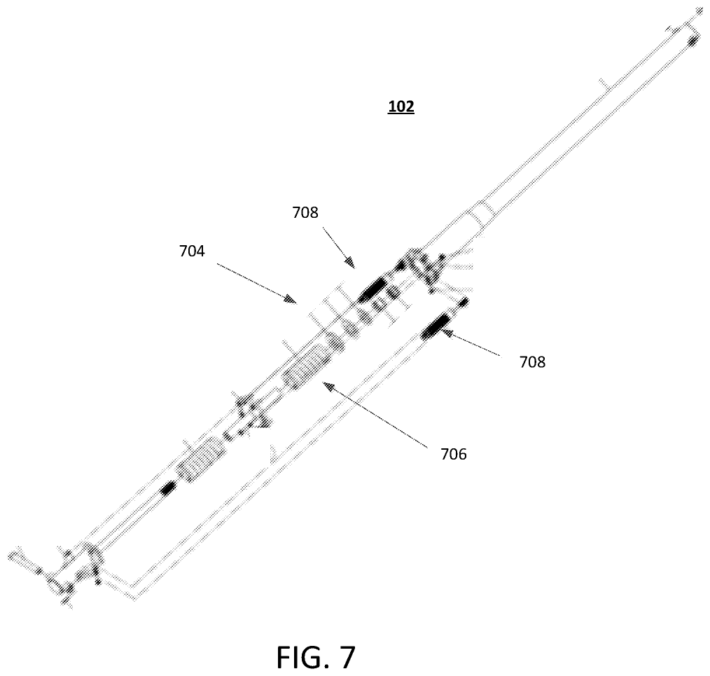

FIG. 6 is a side view of a tillage tool showing relative displacement 602 for the location of a damping element. FIG. 7 is a schematic of a leveling spring damper system. The leveling system 102 is designed to keep the frame level as the tillage tool 200 is transitioned between the transport and working positions. A spring link 704 is included in this leveling system 102 and allows the frame to pitch to avoid too high of a load on the system. This spring link 704 allows relative motion between two components in the system for energy dissipation with shock absorbers. The spring link 704 includes springs 706 that provide a change in length of the leveling link. The size of these springs depend on the position of the depth gauging wheels being substantially at the center of gravity of the tillage tool 200. A pair of shock absorbers in the leveling system 102 include respective damping elements 708. A damping element 708 can include a gas, oil, or a combination of gas and oil. Other forms of energy dissipation devices for damping can also include frictional dampers, partical damping, etc.

### Depth Gauging Wheel Location Near the Center of Gravity

In conventional high speed or compact disc tools the depth gauging components are located at the extreme front or rear position on the machine. To allow a spring and damper to be incorporated in the leveling system the spring must be sufficiently stiff to support a majority of the machine's mass. A sufficiently stiff spring will not provide the needed relative motion for damping while a softer spring will not maintain machine levelness.

Conventional approaches do not consider energy dissipation in the leveling system but rely only on energy dissipation through interactions with the ground. This solution provides leveling system damping which requires relative motion between two components in the leveling system. To achieve this motion a spring is needed that can allow the frame to pitch when disturbed while at the same time keeping the machine level in normal operating conditions.

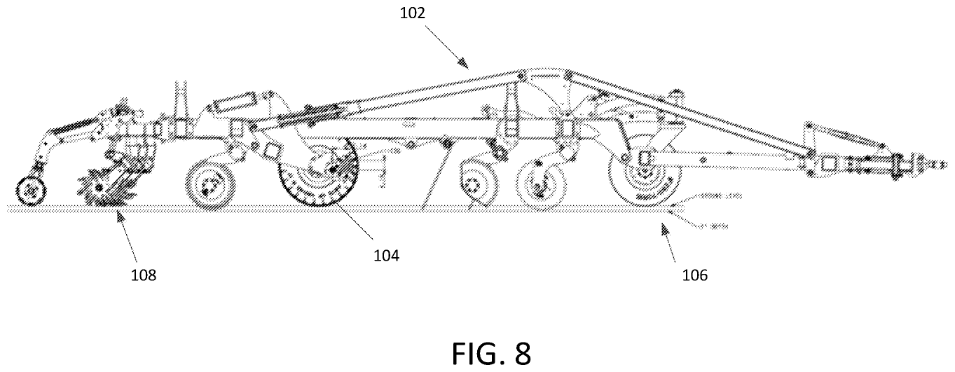

FIG. 8 is a side view of a tillage tool with a depth gauging wheel located substantially near the center of gravity. By placing the depth gauging wheels 104 substantially near the center of gravity of the tilling tool 200 a relatively soft spring will keep the tool 200 level since most of the weight of the tool is located directly over the depth gauging wheels. This relatively soft spring can provide the needed motion for system damping.

As a ground disturbance causes the frame of the tillage tool 200 to pitch, it will pitch about the depth gauging wheels 104 if the wheels are located near the center of gravity of the tool. This pitching provides the needed motion for damping. On the other hand, when there are no disturbances from the ground the weight of the tillage tool 200 rests over the tires and can easily be held stable by the soft spring.

### Rear Tool Active Response and Damping

Position controlled rear tools store and release energy as the ground level changes. This energy cannot be dissipated within the system. In disclosed embodiments, rear tools can be any tool attachable to a towable disc system for working soil. Rear tools can include, but are not limited to, cage rollers, rubber rollers, rolling harrows, rolling baskets, packing wheels. These various types of rear tools can be used alone or in combination with other tools.

A conventional approach to controlling rear tools is to use a position controlled rear tool with either a rigid connection to the frame or with a spring relief for overload protection. A position-controlled system cannot dampen vertical motion but only stores energy aggravating machine instability. A load-controlled system, however, dissipates energy which dampens machine vertical motion.

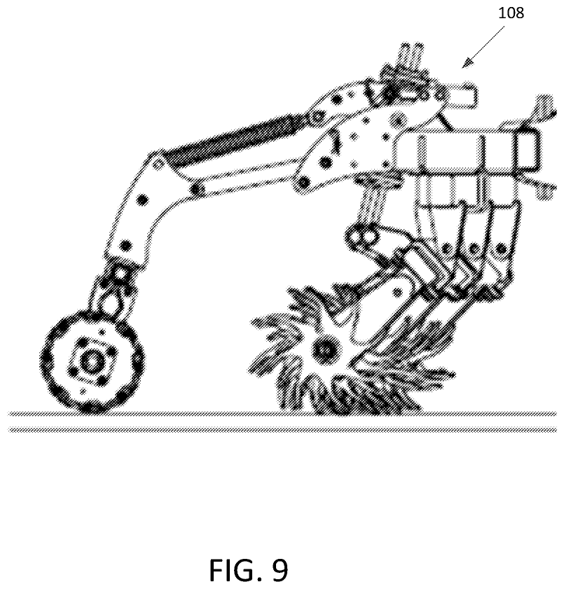

FIG. 9 is a schematic of a rear tool system. One embodiment provides damping to the tillage tool 200 through the pressure relief in the constant flow pressure relief hydraulic actuator in the rear tool system 108.

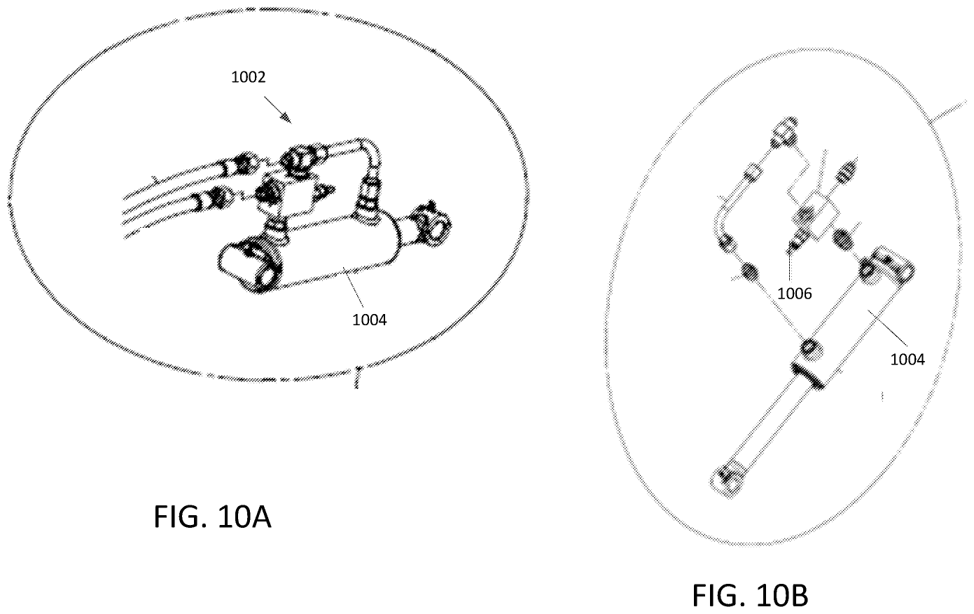

FIGS. 10A, 10B illustrates a hydraulic actuator for the rear tool system. A hydraulic cylinder 1004 is used to allow the rear tool 108 to follow the contour of the ground. The hydraulic system for controlling the hydraulic actuator for the rear tool is similar to the hydraulic system in FIG. 5 for the front support wheel system 106. A pressure reducing valve is used to provide a constant pressure to the hydraulic cylinder 1004 as the cylinder volume increases due to a lowering of the rear tool 108. A pressure relief valve 1006 is located as close as possible to the cylinder and is used to discharge excess oil to the other end of the hydraulic cylinder 1004 and back to a tank when there is a rapid raising of the rear tool 108.

This hydraulic reducing and relief system maintains a set force on the rear tool 108 regardless of the change in the tool's position relative to the frame, while at the same time dissipating energy as oil flows through the system.

### Initial Machine Setup and Depth Adjustments

### Adjustable Initial Length of a Hydraulic Cylinder

Wing sections of a tillage tool require the ability to adjust the wing depth gauging wheels relative to the center section depth gauging wheels 104 to tune a tillage tool's lateral levelness.

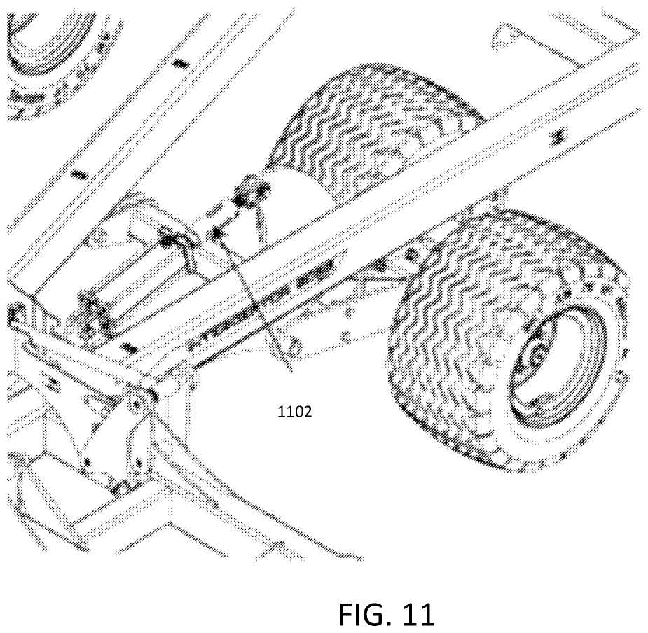

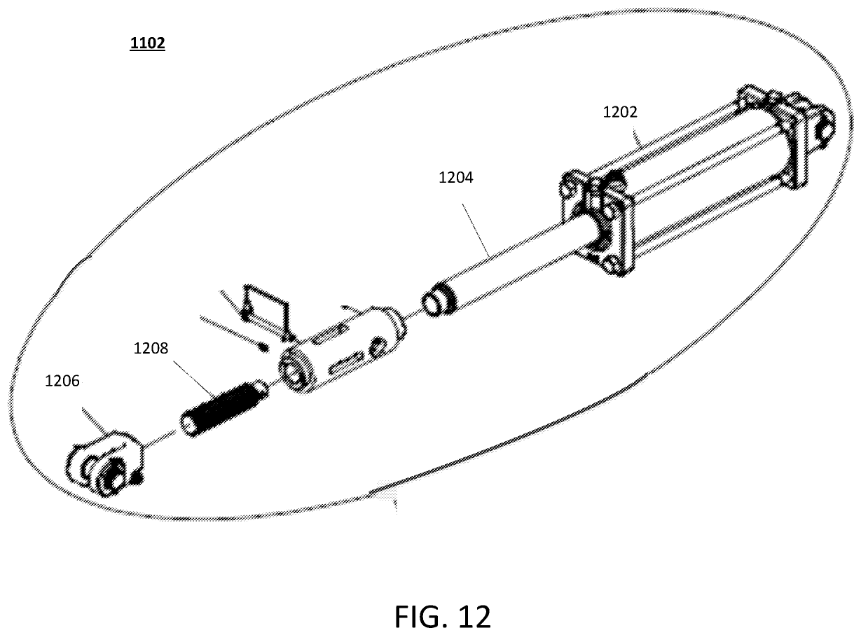

Conventional turnbuckles require both a right-hand and a left-hand threaded connection. FIG. 11 is a schematic of a hydraulic cylinder to adjust the wing depth gauging wheels. FIG. 12 is a detailed view of the adjustable length hydraulic cylinder 1102. In one embodiment, a hydraulic cylinder's 1202 retracted length is allowed to be changed by a single screw 1208 incorporated in between the end of the rod 1204 and the clevis 1206. This length adjustment can be done without removing the cylinder clevis pins. Thus, compared to a conventional machine in which the depth is adjusted by turning each of a right-hand and a left-hand threaded connection of a turnbuckle, the depth in the machine of the present invention may be adjusted by turning a single screw.

In operation, pressure is removed from the cylinder 1202 to allow the rod 1204 to rotate freely. The rod 1204 is then rotated causing the screw to extend or retract changing the overall length of the cylinder 1202.

### Front Support Wheels Constant Force Control

Position controlled front support wheels must have their position adjusted to maintain ideal position control when the operator wants to change the working depth of the tillage tool.

A conventional approach for controlling front support wheels is to use a position controlled front support wheel with either a rigid connection to the frame or with a spring relief for overload protection. Load controlled front support wheels will maintain the correct supporting force regardless of the depth of operation.

Referring back to FIGS. 3, 4A, 4B hydraulic cylinder 404 is used to allow the front support wheels to follow the contour of the ground. A pressure reducing valve is used to provide a constant pressure to the hydraulic cylinder 404 as the cylinder volume increases due to a lowering of the wheel. A pressure relief valve 406 is located as close as possible to the cylinder is used to discharge excess oil to the other end of the cylinder and back to the tank when there is a rapid raising of the wheel.

This hydraulic reducing and relief system maintains a set force on the front support wheel regardless of the change in the wheel's position relative to the frame.

1. A towable disc tillage tool, comprising:
a plurality of discs for mixing at a predetermined soil depth; and
a stability control system including a combination of mechanical and hydraulic dynamic force control through damping of the leveling linkage, front support wheels, rear tools and the position of the depth gauging wheels.

2. The disc tillage tool of claim 1, wherein the
at least one depth gauging wheel is located substantially at the center of gravity of the disc tillage tool.

3. The disc tillage tool of claim 1, wherein the leveling linkage includes a spring link to allow relative motion between two components for energy dissipation through a damping element.

4. The disc tillage tool of claim 1, wherein the at least one depth gauging wheel includes
a plurality of wing depth gauging wheels and at least one center section depth gauging wheel, wherein hydraulic actuators are used to vary the depth of the machine,
wherein the wing depth gauging wheels are adjustable relative to a center section the at least one depth gauging wheel to tune a machine's lateral levelness.

5. The disc tillage tool of claim 1, further comprising:
a plurality of wing depth gauging wheels and respective hydraulic actuators,
wherein each of the respective hydraulic actuators includes a single screw incorporated in between an end of a rod and a clevis to allow adjustment of a length of the respective hydraulic actuator without removing a pin of the clevis.

6. A wing depth gauging wheel for a towable disc system, comprising:
a tire mounted to a hub;
a movable arm connected to the hub
a length adjustable hydraulic actuator; and
a single screw incorporated in between an end of a rod and a clevis of the hydraulic actuator for adjustment of a length of the hydraulic actuator.

7. The wing depth gauging wheel of claim 6,
wherein the length of the hydraulic actuator is adjusted by removing pressure from a respective hydraulic cylinder to allow the rod to rotate freely, then rotating the rod causing the screw to extend or retract to change the length of the hydraulic actuator.

8. A support wheel apparatus for a towable disc system:
a tire mounted to a hub;
a movable arm connected to the hub;
a wheel hydraulic actuator with hydraulic flow restriction, the hydraulic actuator attached to the movable arm to control the movement of the movable arm.

9. The support wheel apparatus of claim 8, further comprising:
a pressure reducing valve to provide a constant pressure to the wheel hydraulic actuator as hydraulic cylinder volume increases due to a lowering of the tire via movement of the movable arm;
a pressure relief valve located proximate to hydraulic cylinder of the wheel hydraulic actuator and used to discharge excess oil to another end of the hydraulic cylinder and back to a tank when there is a rapid raising of the tire.

10. The support wheel apparatus of claim 9, wherein the hydraulic reducing and relief by respective valves maintains a set force on the support wheel regardless of change in the support wheel's position relative to a frame.

11. A rear tool attachable to a towable disc system, comprising:
a soil working element;
a positioning assembly mounted to the soil working element;
a hydraulic actuator with hydraulic flow restriction, the hydraulic actuator attached to the positioning assembly to control the movement of the positioning assembly.

12. The rear tool of claim 11, wherein the hydraulic actuator includes pressure relief to allow constant flow pressure relief,
wherein the pressure relief comprises:
a pressure reducing valve to provide constant pressure to the hydraulic actuator as hydraulic cylinder volume increases due to a lowering of the rear tool; and
a pressure relief valve located proximate to a hydraulic cylinder of the hydraulic actuator used to discharge excess oil to another end of the hydraulic cylinder and back to a tank when there is a rapid raising of the rear tool.
